(19) United States
(12) Patent Application Publication
(10) Pub. No.: US 2007/0235638 A1
(43) Pub. Date: Oct. 11, 2007

(54) Optical sensor device

(75) Inventors: Ulrich Backes, Radolfzell (DE); Andreas Kail, Rielasingen (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Electronics & Components GmbH & Co. KG

(21) Appl. No.: 11/728,837

(22) Filed: Mar. 27, 2007

(30) Foreign Application Priority Data
Apr. 5, 2006 (DE) 20 2006 005 665.3

(51) Int. Cl. G02B 6/26

(52) U.S. Cl. 250/227.24

(57) ABSTRACT

An optical sensor device (10, 10′) is able to be coupled to a pane (14), particularly to a windscreen of a motor vehicle. A sensor unit (12) of the device (10, 10′) has a transmitter (26), a receiver (28) and a photoconductor structure with a first fresnel lens (42) associated with the transmitter (26) and a second fresnel lens (44) associated with the receiver (28). The fresnel lenses (42, 44) are arranged such that a diverging light beam (34) emitted from the transmitter (26) is oriented in parallel through the first fresnel lens (42) and is coupled into the pane (14) as a parallel light beam (34a) without further substantial deflection. The parallel light beam (34a) is coupled out from the pane (14) as a parallel light beam (34b) after at least one reflection inside the pane (14). The light beam (34b) impinges onto the receiver (28) as a converging light beam through the second fresnel lens (44).

### TECHNICAL FIELD

The invention relates to an optical sensor device which is able to be coupled to a pane, particularly to a windscreen of a motor vehicle.

### BACKGROUND OF THE INVENTION

Such sensor devices are principally used as rain sensors in motor vehicles for automatic activation of the windscreen wipers. The use of traditional lenses to influence the path of rays, such as for example the lenses inclined towards the windscreen in the rain sensor shown in EP 1 068 112 B1, require a relatively large amount of space.

Smaller types of construction, such as are known for example from WO 03/026937 A1, are possible through the use of holographic sensors. These sensors are based on the principle of the diffraction of light by means of defractive elements and therefore have the disadvantage, due to the inherent principle, of a substantially smaller useful light efficiency and a higher sensitivity to glare.

An optical sensor device which is able to be coupled to a windscreen of a motor vehicle and includes a sensor unit having a transmitter, a receiver, and a photoconductor structure with a first fresnel lens associated with the transmitter and a fresnel lens associated with the receiver is shown in DE 196 08 648 C1. In order to reduce the distance between the transmitter, or the receiver, respectively, and the photoconductor structure, it is proposed to construct the light entry and exit areas of the photoconductor structure as fresnel lenses. The necessary structural space for this device is nevertheless very large owing to the complex photoconductor structure, which requires an arrangement of the printed circuit board, carrying the transmitter and receiver, perpendicularly to the windscreen.

It is an object of the invention to provide an optical sensor device which only requires a small amount of space and nevertheless can scan a sufficiently large area on the pane (sensor area).

### SUMMARY OF THE INVENTION

According to the invention, an optical sensor device which is able to be coupled to a pane, particularly to a windscreen of a motor vehicle, includes a sensor unit having a transmitter, a receiver, and a photoconductor structure with a first fresnel lens associated with the transmitter and a fresnel lens associated with the receiver. The fresnel lenses are arranged such that a diverging light beam emitted from the transmitter is oriented in parallel through the first fresnel lens and is coupled into the pane as a parallel light beam without further substantial deflection. The parallel light beam is coupled out from the pane after at least one reflection inside the pane as a parallel light beam. The light beam impinges onto the receiver as a converging light beam through the second fresnel lens. The invention is based on the finding that a relatively large sensor area is produced with a parallel-oriented light beam with suitable oblique coupling into the pane. After the coupling of the parallel light beam out from the pane, the parallel light beam is then focused onto the receiver. The fresnel lenses have a smaller thickness compared with traditional lenses and can therefore be constructed so that they make an oblique coupling of the light beam possible into or out of the pane with a space-saving arrangement parallel to the pane.

The fresnel lenses are preferably constructed and arranged such that the parallel light beam is coupled into the pane, or out from the pane, respectively, at an angle of approximately 45°.

An embodiment in which the two fresnel lenses are arranged adjacent to each other and are formed as one piece is particularly favourable for the production and assembly of the sensor device according to the invention. In particular, the two fresnel lenses can be formed in a plate, a front side of the plate having fresnel steps, the plate being arranged so that the front side of the plate faces the transmitter or the receiver. Apart from the simplified production of the lenses, in which only the necessary fresnel steps have to be worked into a parallelepiped-shaped plate of suitable optical material, the relative arrangement of the two fresnel lenses to each other is securely pre-set and cannot change either during assembly or in the mounted state owing to mechanical effects.

### BRIEF DESCRIPTION OF THE DRAWINGS

FIG. 1 a top view of a first embodiment of the optical sensor device according to the invention;

FIG. 2 a sectional view along the line A-A in FIG. 1; and

FIG. 3 a top view of a second embodiment of the optical sensor device according to the invention.

### DETAILED DESCRIPTION OF THE PREFERRED EMBODIMENTS

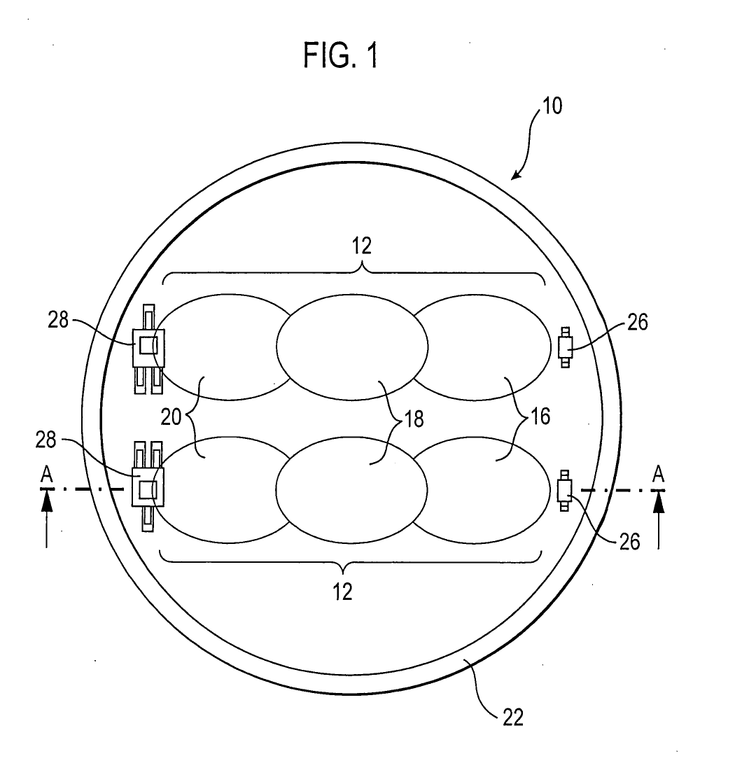

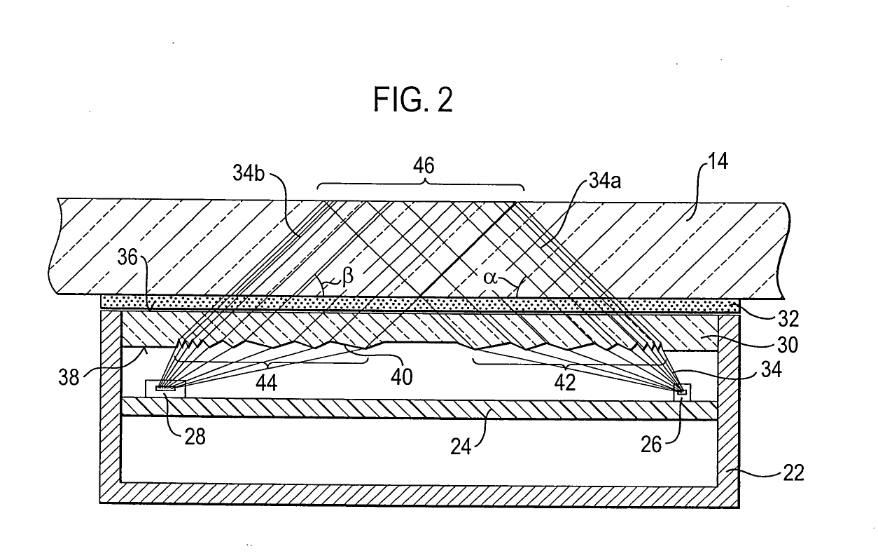

In FIG. 1 a first embodiment of an optical sensor device 10 according to the invention is shown, with two similar sensor units 12 to detect the wetting of a pane. The sensor device 10 is described below for use as a rain sensor which is mounted on a windscreen 14 (see FIG. 2) of a motor vehicle. Some components of the sensor device 10 are omitted in the illustration of FIG. 1, in order to emphasize the areas of light impingement 16, 18, 20 which will be described in further detail later.

The basic structure of the sensor units 12 can be seen from the sectional illustration of FIG. 2. A printed circuit board 24 with a transmitter 26 and a receiver 28 for each sensor unit 12 is accommodated in a housing 22 which is open on one side. In the installed state of the sensor device 10, i.e. when the sensor device 10 is attached to a windscreen 14, the windscreen 14 and the printed circuit board 24 are oriented substantially parallel to each other. A photoconductor structure, the essential component of which is a lens plate 30, is arranged between the printed circuit board 24 and the windscreen 14. The housing 22 and the printed circuit board 24 are fastened to the windscreen 14 by a coupler 32.

The transmitter 26 emits light in a particular frequency range. The term “light” is not restricted to visible light, but may also comprise radiation in the infrared range, for example. The light is emitted from the transmitter 26 as a diverging beam of light 34 directed onto a first partial section of the lens plate 30. The receiver 28 is coordinated with the transmitter 26 and emits signals to an evaluation unit (not shown) in accordance with the registered light incidence.

The lens plate 30 is basically parallelepiped-shaped and is arranged parallel to the windscreen 14. The lens plate 30 has a substantially flat rear side 36 facing the windscreen 14. The front side 38 of the lens plate 30, facing the transmitter 26 or the receiver 28, has fresnel steps 40. The lens plate 30 can be divided into several sections. The previously mentioned first partial section forms an aspherical first fresnel lens 42, the optical axis of which is inclined through approximately 45° with respect to the windscreen 14. A second partial section of the lens plate 30 forms an aspherical second fresnel lens 44, the optical axis of which is inclined in the opposite direction, likewise through approximately 45° with respect to the windscreen 14. The two fresnel lenses 42, 44 are constructed so as to be in mirror symmetry to each other. Starting from a parallelepiped-shaped plate of suitable optical material, only slight modifications are necessary on its front side to form the necessary fresnel steps 40, for the production of the fresnel lenses 42, 44.

In the illustrated example embodiment, the coupler 32 is formed by a transparent, elastic and substantially flat medium which does not have any significant refraction characteristics in the frequency range of the light emitted by the transmitter 26.

In operation, the diverging light beam 34, emitted by the transmitter 26 towards the lens plate 30, impinges onto the first fresnel lens 42 (light impingement area 16 in FIG. 1). The first fresnel lens 42 provides for a substantially parallel orientation of the rays of the light beam 34. The rays are therefore coupled into the windscreen 14 by the coupler 32 as a parallel-oriented light beam 34a. The entry angle α is approximately 45°. The light beam 34a is reflected totally in the windscreen 14, the orientation of the light rays remaining parallel. The impingement area of the light beam 34a which is coupled in parallel into the windscreen (light impingement area 18 in FIG. 1) defines the sensor area 46, i.e. the area of the windscreen 14 which is examined for wetting by means of the respective sensor unit 12.

Owing to the symmetrical construction of the coupler 32 and of the lens plate 30, the path of rays of the light beam after total reflection on the windscreen 14 is symmetrical to the path of rays previously described. This means that the reflected parallel light beam 34b is coupled out from the windscreen 14 via the coupler 32 at an exit angle β of approximately 45°, and into the second partial section of the lens plate 30 (light impingement area 20 in FIG. 1), and the second fresnel lens 44 focuses the light beam 34b onto the receiver 28.

In an alternative variant of the coupler (not shown), the coupler has a rigid element with a rear side facing the windscreen 14 and a front side facing the photoconductor structure. The rear side is adapted to the shape of the windscreen 14 (i.e. it is substantially flat) and is fastened to the windscreen 14 by an adhesion agent. The front side has coupling areas which are oriented perpendicularly to the parallel orientation of the light beam. In this case, the photoconductor structure has a rear side which is adapted to the front side of the rigid coupler element and is connected therewith.

For a better signal evaluation, the signals delivered from the receivers 28 of the sensor unit pair are subjected to a subtraction in the evaluation unit. The same applies to any further pairs of sensor units 12 which belong to the sensor device 10.

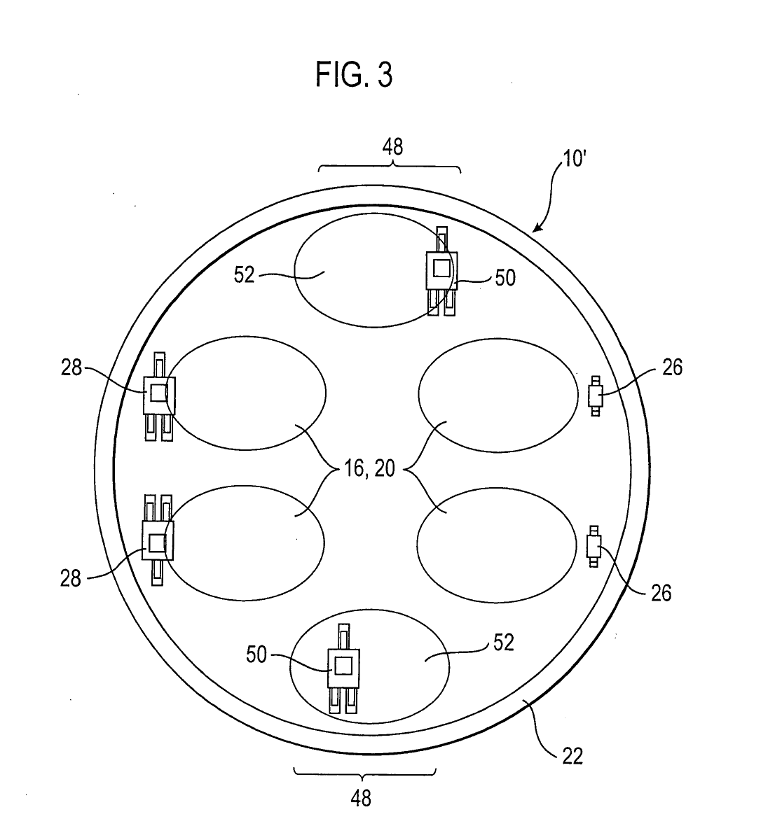

In FIG. 3 a second embodiment of a sensor device 10′ is shown in accordance with a further development of the invention. In addition to the sensor units 12 to detect the wetting of the windscreen 14, additional daylight sensor units 48 are provided here. The daylight sensor units 48 have a light receiver 50 and a photoconductor structure in each case with a further fresnel lens (not visible in FIG. 3), which is constructed and arranged in accordance with the fresnel lenses 42, 44 previously described. Each fresnel lens of the daylight sensor units 48 displays light from a defined region 52 of the environment on the associated light receiver 50. In this way the functionality is extended in that with the sensor device 10′ of compact construction, an automatic control of the headlights is also made possible in addition to an automatic actuation of the windscreen wipers.

In all the embodiments, it is basically possible to construct several or even all the fresnel lenses in a single lens plate.

1. An optical sensor device which is able to be coupled to a pane, particularly to a windscreen of a motor vehicle,
the device comprising a sensor unit including a transmitter, a receiver and a photoconductor structure having a first fresnel lens associated with the transmitter and a second fresnel lens associated with the receiver,
the fresnel lenses being arranged such that a diverging light beam emitted from the transmitter is oriented in parallel through the first fresnel lens and is coupled into the pane as a parallel light beam without further substantial deflection,
the parallel light beam being coupled out from the pane as a parallel light beam after at least one reflection inside the pane,
the light beam impinging onto the receiver as a converging light beam through the second fresnel lens.

2. The optical sensor device according to claim 1, wherein the first fresnel lens is constructed and arranged such that the parallel light beam is coupled into the pane at an angle of approximately 45°.

3. The optical sensor device according to claim 1, wherein the second fresnel lens is constructed and arranged such that the parallel light beam is coupled out from the pane at an angle of approximately 45°.

4. The optical sensor device according to claim 1, wherein the two fresnel lenses are constructed in mirror symmetry to each other.

5. The optical sensor device according to claim 1, wherein the two fresnel lenses are arranged adjacent to each other and are formed as one piece.

6. The optical sensor device according to claim 1, wherein the two fresnel lenses are formed in a plate, a front side of the plate having fresnel steps, the plate being arranged such that the front side of the plate faces one of the transmitter and the receiver.

7. The optical sensor device according to claim 6, wherein a rear side of the plate opposite the front side is substantially flat and faces the pane.

8. The optical sensor device according to claim 1, wherein the photoconductor structure is attached to the pane by a coupler.

9. The optical sensor device according to claim 8, wherein the coupler is formed by a transparent, elastic and substantially flat medium.

10. The optical sensor device according to claim 8, wherein the coupler has a rigid element with a rear side facing the pane and a front side facing the photoconductor structure, the rear side being substantially flat and the front side having coupling areas which are formed perpendicularly to the parallel orientation of the light beam.

11. The optical sensor device according to claim 10, wherein the photoconductor structure has a rear side adapted to the front side of the rigid element of the coupler.

12. The optical sensor device according to claim 1, wherein the transmitter and the receiver are arranged on a printed circuit board which is oriented substantially parallel to the pane.

13. The optical sensor device according to claim 1, comprising an even number of sensor units and an evaluation unit, the receivers of the sensor units delivering signals, the signals of each pair of sensor units being subjected to a subtraction in the evaluation unit.

14. The optical sensor device according to claim 1, wherein at least one additional daylight sensor unit is accommodated in a housing of the sensor device, the daylight sensor unit having a light receiver and a photoconductor structure with a further fresnel lens which displays light from a defined region of the environment on the light receiver.

15. The optical sensor device according to claim 14, wherein the further fresnel lens and at least one of the first and second fresnel lenses are formed in the same plate.
